(19) United States
(12) Patent Application Publication
(10) Pub. No.: US 2009/0254512 A1
(43) Pub. Date: Oct. 8, 2009

(54) AD MATCHING BY AUGMENTING A SEARCH QUERY WITH KNOWLEDGE OBTAINED THROUGH SEARCH ENGINE RESULTS

(75) Inventors: Andrei Broder, Menlo Park, CA (US); Marcus Fontoura, Mountain View, CA (US); Evgeniy Gabrilovich, Sunnyvale, CA (US); Vanja Josifovski, Los Galos, CA (US); Lance Riedel, Menlo Park, CA (US)

Correspondence Address: YAHOO! INC.;c/o DUANE MORRIS LLP, Attn.: IP Docketing, 1 Market Plaza - 2000 Spear Tower, San Francisco, CA, 94105-1104, US

(73) Assignee: Yahoo! Inc., Sunnyvale, CA (US)

(21) Appl. No.: 12/062,271

(22) Filed: Apr. 3, 2008

(51) Int. Cl. G06F 7/06; G06F 17/30

(52) U.S. Cl. 707/2; 707/E17.119

(57) ABSTRACT

A method is provided to match an advertisement to a search query comprising: receiving search results produced by a search engine in response to a search query; producing an ad query that includes, unigram features, classification features with respect to an external classification system, and phrase features; producing a plurality of representations of corresponding advertisements in terms of the same types of features; and selecting one or more advertisements based upon a measure of similarity of ad query features to advertisements represented in terms of the same features.

### BACKGROUND OF THE INVENTION

1. Field of the Invention

The invention relates in general to computer networks, and more particularly, to matching of advertisements with content provided over the Internet.

2. Description of the Related Art

The Worldwide Web (the “Web”) provides access to a distributed collection of documents or more generally, a collection of files via the Internet. The Web uses a client-server model in which servers referred to as a Web servers, serve database records to client devices. The database records are stored in the form of electronic documents known as “pages”. In this manner, the Web provides access to a vast database of information dispersed across an enormous number of individual computer systems. Computers connected to the Internet may search for and retrieve Web pages via a computer program known as a browser, which has a powerful, simple-to-learn graphical user interface. One technique supported on a Web browser is known as hyperlinking, which permits Web page authors to create links to other Web pages which users then can retrieve by using simple point-and-click commands on the Web browser. Web pages may be constructed in any of a variety of formatting conventions, such as Hyper Text Markup Language (HTML), and may include multimedia information content such as graphics, audio, and moving pictures.

A user typically employs a search engine to navigate the Web. A search engine provides an index structure that is routinely updated to facilitate search of perhaps, billions of Web pages. A user directs a client device to request a search engine server to search for Web pages on the Internet that meet search criteria set forth in a user's search query. A typical search engine employs automated search technology that relies in large part on complex, mathematics-based database search algorithms that can select and rank Web pages based on multiple criteria such as keyword density and keyword location. A search engine server responds to a search query by delivering a response that includes one or more hyperlinks to one or more Web pages that satisfy the search request.

Advertising has become a part of the economic underpinning of the Web. A large part of the Web advertising market consists of textual ads, which are the ubiquitous short text messages often marked to indicate that they are sponsored (or paid for) links. The primary advertising channels used to distribute textual ads are sponsored search and contextual advertising. Ordinarily, in sponsored search advertising, ads are placed on the result pages of a Web search engine, with sponsored ad selections being driven by the user's original search query. Content match, or contextual advertising, involves placing commercial ads on generic Web pages. Today, almost all of the for profit non-transactional Web sites rely at least to some extent on contextual advertising revenue.

Under a sponsored search business model, for example, a few carefully-selected paid advertisements are displayed alongside algorithmic (or organic) search results. For instance, a search request response returned by a search engine server may include both so-called organic (i.e., algorithmic) search results and sponsored link results. Organic results indicate URLs associated with Web pages identified by a search engine's search algorithm based upon database search criteria free of any bias imposed by link sponsorship. Sponsored links typically are associated with network location identifiers, typically URLs that are associated with sponsors who may have some prior agreement with a provider of the search engine server to display their ads or links to their Web pages in association with content selected by a search engine in response to a user search query.

There is a fine but important line between placing ads reflecting the query intent, and placing unrelated ads. Users may find the former beneficial, as an additional source of information or an additional Web navigation facility, while the latter are likely to annoy the users for no economic benefit. Identifying relevant ads is far from trivial, mainly because search queries are so short—the average query is only about 2.5 words long, and because the user, consciously or not, generally chooses query terms intended to lead to the best Web results not to the best ads. Thus, to identify ads that are more relevant, it makes sense to consider suitable query expansions or substitutions before searching the available ad database. In the realm of Web search (and more generally within the field of information retrieval), there have been a number of studies on query augmentation for Web searches. See for example, Eugene Agichtein, Steve Lawrence, and Luis Gravano, “Learning search engine specific query transformations for question answering,” in Proceedings of the 10th International World Wide Web Conference (WWW10), pages 169-178, Hong Kong, May 2001, ACM Press; Lisa Ballesteros and Bruce Croft, “Phrasal translation and query expansion techniques for cross-language information retrieval,” in Proceedings of the 20th ACM International Conference on Research and Development in Information Retrieval, pages 84-91, 1997; Mandar Mitra, Amit Singhal, and Chris Buckley, “Improving automatic query expansion,” in Proceedings of the 21st ACM International Conference on Research and Development in Information Retrieval, pages 206-214, 1998; Ellen M. Voorhees, “Query expansion using lexical-semantic relations,” in Proceedings of the 17th International Conference on Research and Development in Information Retrieval, pages 61-69, 1994; Jinxi Xu and W. Bruce Croft, “Query expansion using local and global document analysis,” in Proceedings of the 19th International Conference on Research and Development in Information Retrieval, pages 4-11, 1996.

One pricing model for textual ads calls for advertisers pay a certain amount for every click on the advertisement (pay-per-click or PPC). There are also other models, such as pay-per-impression, where the advertiser pays for the number of exposures of an ad, and pay-per-action, where the advertiser pays only if the ad leads to a sale or similar completed transaction. Often, an auction process determines the amount paid by an advertiser for each sponsored search. See for example, B. Edelman, M. Ostrovsky, and M. Schwarz, “Internet advertising and the generalized second price auction: Selling billions of dollars worth of keywords,” American Economic Review, 97(1):242-259, 2007. The advertisers place bids on a search phrase, and their position in the tower of ads displayed on the search results page is determined by their bid.

Accordingly, each ad typically is annotated with one or more bid phrases. In addition to the bid phrase, an ad is also ordinarily characterized by a title often displayed in bold font, and an abstract or “creative”, which includes a few lines of text, usually shorter than 120 characters, displayed on the page. Each ad also typically contains an address (e.g. URL) for the advertised Web page, called the landing page.

In a model currently used by major search engines, bid phrases serve a dual purpose: they explicitly specify queries that the ad should be displayed for and simultaneously put a price tag on an advertisement event, such as a user clicking on a sponsored ad link. These price tags can be different for different queries. For example, a contractor advertising his services on the Internet might be willing to pay a small amount of money when his ads are clicked from general queries such as “home remodeling”, but higher amounts if the ads are clicked from more focused queries such as “hardwood floors” or “laminate flooring”. In other words, an advertiser may be willing to pay more if the query is more relevant to the advertiser's product or service. Most often, ads are shown for queries that are expressly listed among the bid phrases for the ad, thus resulting in an exact match (i.e., identity) between the query and the bid phrase. However, it might be difficult (or even impossible) for the advertiser to list all the relevant queries ahead of time. Therefore, some search engines also have the ability to analyze queries and modify them slightly in an attempt to match predefined bid phrases. This approach, called broad or advanced match, facilitates more flexible matching of ads, but is also more error-prone, and only some advertisers use it. Nonetheless, bid phrases remain a significant component of the ad definition.

The volume of queries in today's search engines follows the familiar power law, where a few queries appear very often while most queries appear only a few times. While individual queries in this long tail are infrequent, collectively they account for a considerable mass of all searches. Furthermore, the aggregate volume of such queries provides a substantial opportunity for income through on-line advertising.

One mainstream approach to textual document retrieval has been based on the so-called “bag of words” paradigm in which both the query and the documents to be retrieved are represented as vectors of word-based features. See, Gerard Salton and Michael McGill. An Introduction to Modern Information Retrieval, McGraw-Hill, 1983. The feature values ordinarily are computed using some variant of the TFIDF (term frequency inverse document frequency) weighting scheme. See, Gerard Salton and Chris Buckley, Term weighting approaches in automatic text retrieval, Information Processing and Management, 24(5):513{523, 1988. The TFIDF concept embodies the intuitions that the more often a term occurs in a document, the more it is representative of its content, and the more documents a term occurs in, the less discriminating it is.

Searching and advertising platforms can be trained to yield even better results for frequent queries, by using auxiliary data such as maps, shortcuts to related structured information, successful ads, and so on. However, the rare queries (i.e. queries used only infrequently) often do not have enough occurrences to allow statistical learning on a per-query basis. Therefore, there has been a need to aggregate such queries in some way, and to reason at the level of aggregated query clusters. One choice for such aggregation is to classify the queries into a topical taxonomy. Knowing which taxonomy nodes are most relevant to the given query aids in providing auxiliary support for rare queries much like that provided for frequent queries. Prior studies in query interpretation focused on query augmentation. See, for example, E. Voorhees, “Query expansion using lexical-semantic relations,” in SIGIR'94, 1994. More recent studies by D. Shen, R. Pan, J. Sun, J. Pan, K. Wu, J. Yin, and Q. Yang, “Q2C@UST: Our winning solution to query classification in KDDCUP 2005,” in SIGKDD Explorations, volume 7, pages 100-110, ACM, 2005 and D. Vogel, S. Bickel, P. Haider, R. Schimpfky, P. Siemen, S. Bridges, and T. Scheffer, “Classifying search engine queries using the web as background knowledge,” in SIGKDD Explorations, volume 7, ACM, 2005.

Thus, there has been a need for improvement in the augmentation of the sparse representation of short queries. The present invention meets this need.

### SUMMARY OF THE INVENTION

In one aspect, a Web search query is augmented with knowledge gleaned from search engine results in order to achieve more effective matching of ads to the search query. The search query itself includes a limited amount of information. Search results produced by a search engine using the search query, however, are rich with information. The search results are processed to produce a set of ad query features that are characteristic of the Web search results.

In another aspect, advertisements are processed to represent the ads with the same set of features used in the ad query. Ads having feature sets that are the most similar to the set of ad query features are identified as likely candidates for selection and display. More particularly, for example, in some embodiments, an ad query is produced that includes unigram features, classification features and phrase features. Ads are processed so as to represent them through the same feature set. A similarity metric is used to identify ads that have feature values that most closely match feature values the ad query.

These and other aspects and advantages of the invention will be apparent to persons skilled in the art through the following detailed description of embodiments thereof in conjunction with the drawings.

### BRIEF DESCRIPTION OF THE DRAWINGS

FIG. 1 is an illustrative flow diagram of an architecture for a process to determine the relevance of advertisements to a search query in accordance with some embodiments of the invention.

FIG. 2 is an illustrative drawing representing structure of an ad query in accordance with some embodiments of the invention and also representing structure of an ad as represented in feature space in accordance with some embodiments of the invention.

FIG. 3 is an illustrative drawing of an ad index structure in accordance with some embodiments of the invention.

FIG. 4 is an illustrative drawing of a portion of an external taxonomy showing branching and a hierarchy of nodes in accordance with some embodiments of the invention.

FIG. 5 is an illustrative block level diagram of a computer system that can be programmed to implement processes involved with extracting feature information from Web search results and with classification of text from Web search results according to an external classification taxonomy in accordance with embodiments of the invention.

### DETAILED DESCRIPTION OF THE PREFERRED EMBODIMENTS

The following description is presented to enable any person skilled in the art to make and use a system and method to determine the relevance of advertisements to a search query based upon a comparison of Web search results obtained using the search query and the content of the ads, in accordance with embodiments of the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

### Overview

A search query is provided to a search engine, which obtains Web search results that may be in the form of multiple Web documents or pages, for example. The search results are processed to construct multiple classes of features that represent search results obtained using the search query and that together serve as an ad query. A plurality of advertisements are processed to construct corresponding features for each of one or more ads or groups of ads from the plurality. Although the ads are indexed with the same set of features as queries, they do not undergo exactly the same processing since currently, ads are not expanded with search results as are the queries. However, in alternative embodiments, ads can be augmented with search results in which case, processing of ads and processing of queries could be even more similar.

Multiple advertisements often are provided as part of an ad campaign, and ads of the campaign may be processed as a group. Thus, the same collection of feature types represent both the ad query and the ads.

The ad query is matched to one or more ads from the plurality of ads by evaluating similarity between features in the ad query and corresponding features of the individual ads or groups of ads. Specifically, the relevance of ads to a search query is determined by comparing ad query features derived from the query search results (e.g. documents or Web pages) to corresponding ad features and computing a measure of similarity between such corresponding features. In some embodiments, relevant ads may be presented to the user in a priority (e.g., an ordering), that is determined not only by the above relevance measurement, but also by a bidding process among advertisers, for example.

More particularly, in some embodiments, an ad query includes at least three types of features. A first type of feature includes words (unigrams) that occur within search results records or pages. As used herein, the term ‘unigram’ includes individual words (not phrases). However, a unigram has a meaning that is somewhat more broad than the term ‘word’, as it also includes other kinds of tokens, namely, numbers and mixed alphanumeric strings (e.g., Win2K). The most representative words are selected for use in addition to the original query words. A second type of feature involves classification of the search results with respect to a large external taxonomy of nodes, and then using a selection technique, such as voting, to determine the optimal classifications for the original query. More precisely, the taxonomy nodes that are most relevant to the query as determined by reference to the search results, as well as their ancestors in the taxonomy, comprise this second type of features. A taxonomy comprises an orderly classification of subject matter according to their natural relationships.

A third type of feature is defined by a large lexicon of terms and phrases, built by analyzing the set of Web pages crawled by the Web search engine. Entries from this lexicon that appear in Web results for the original query are identified, and the most representative ones are retained as additional features. See, for example, Peter Anick, “Using terminological feedback for web search refinement: a log-based study” in SIGIR'03, pages 88-95, 2003, which is expressly incorporated herein by this reference.

Ads undergo a similar processing as described above, involving word analysis, classification into an external taxonomy, and extraction of lexicon phrases. Once both the ad query and the ads have been processed to be represented in this augmented space of features as described, determining similarity among the ad query and ads can be achieved by computing similarity metrics such as cosine, for example. See, for example, Justin Zobel and Alistair Moffat, Exploring the similarity space, ACM SIGIR Forum, 32(1):18{34, 1998. Ads having features that most closely match the features of the ad query are determined to be the most relevant to the user's original search query.

Therefore, in one aspect, a methodology is provided for cross-corpus query expansion in which one corpus (the Web) is used to augment queries to be evaluated against another corpus (the ads). In another aspect, new features are constructed based on external knowledge, (e.g. an external taxonomy), which provides a richer representation of both queries and ads. In yet another aspect, the requirement that advertisers explicitly specify “bid phrases”, may be relaxed. Instead, substantially the entire content of an ad can be used to identify user search queries for which the ad should be shown. Thus, using a combination of classification-based and phrase-based features facilitates thematic matching goes beyond the simple bag of words approach and captures at least some semantic similarity.

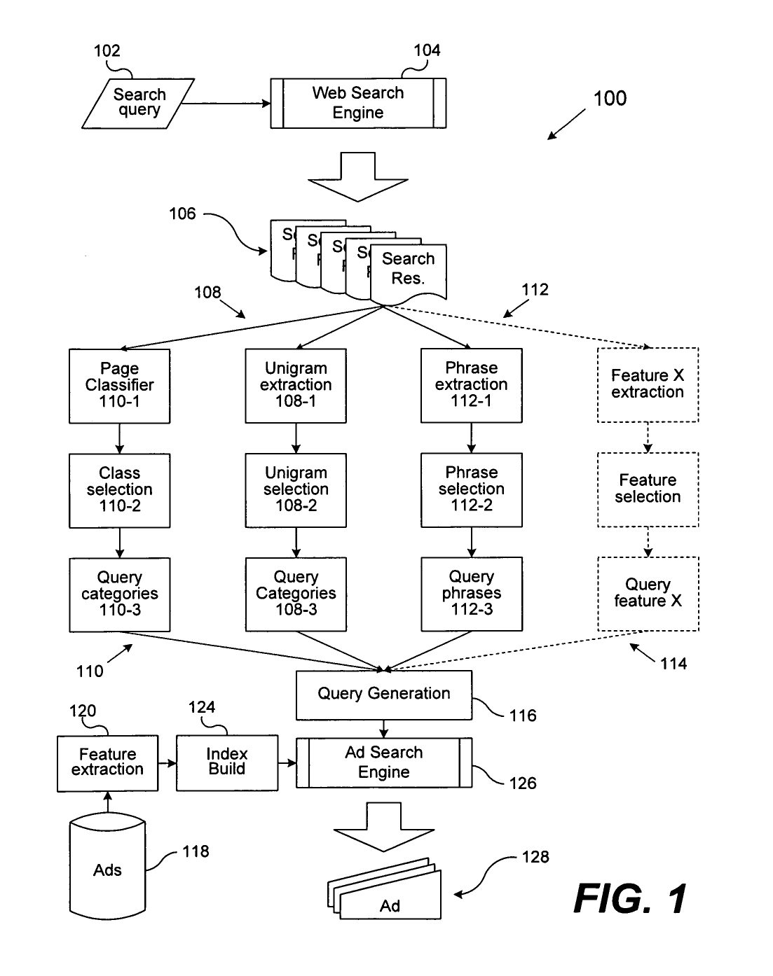

FIG. 1 is an illustrative flow diagram of an architecture for a process 100 to determine the relevance of advertisements to a search query in accordance with some embodiments of the invention. A computer system encoded with computer program instructions performs the illustrated process. A search request 102 is provided to a Web search engine 104 that performs a search on the Internet for content such as Web pages that meet the search request. In response to a typical Web search query 102, the search engine 104 produces multiple search results items 106 ranked based upon relevance to the search query according to scoring criteria used by the search engine 104.

A selected subset of the search results 106 are processed to represent the search results in multiple distinct feature spaces. Typically, a subset of the returned results 106 identified as most relevant according to the search engine criteria is selected for processing. The search results are represented in feature spaces formed using multiple different kinds of features, namely unigrams, classes and phrases, although the search results may be represented with different features, consistent with the principles of the invention. Thus, the primary source of information to augment a user's search query and to construct new features is a set of top-scoring search results 106 for that search query 102. It is assumed that most of the top-scoring results according to the Web search engine ranking criteria are relevant to the query to some extent.

Unigram processing 108 produces unigram features for the search results 106. A unigram extraction process 108-1 tokenizes the text into individual unigrams, removes stopwords and stems the remaining words. A unigram selection process 108-2 retains only the most important unigrams based on their weights, computed using a DF (document frequency) metric. A query unigrams process 108 collects the features selected by the previous model, and assigns them TFIDF weights. Unigram features comprise individual unigrams, and hence using these features ignores any possible dependencies between the words in the text. Such dependencies are captured by the other two feature types described below.

Classification processing 110 produces classification features for the search results 106. A page classifier process 110-1 classifies Web pages onto a large taxonomy of topics. A Web page is input to the classification process, and a set of relevant taxonomy nodes is output by the process. A class selection process 110 retains a selected number (e.g., 5) top-scored classes and their ancestors in the hierarchy. A query categories process 110-3 collects features selected by the previous module 110-2, and uses them to build the corresponding part of the query vector. Feature weights are set equal to scores produced by the classifier. Ancestor nodes are taken with scores decreased by some factor (e.g., 2) at each level. Classification features provide generalization ability. For instance, if a query and an ad discuss the same topics using very different words, then unigram features will not discover that they're related. Classification will generalize from individual words to concepts, and will thus allow to match the query to the ad.

Phrase processing 112 produces phrase features for the search results 106. A page phrase extraction process 112-1 identifies the most salient phrases in the text, using a static list of globally important phrases identified by analyzing the Web. A phrase selection process 112-2 retains the most important phrases based on their weights, computed using a DF (document frequency) metric. A query phrases process 112-3 applies TFIDF values to the selected phrase features and uses these to build the corresponding part of the query vector.

Using unigrams essentially overlooks possible dependencies between text words, for example. However, word combinations (e.g., phrases or proper names) usually have meanings that are different or more refined than the sum of meanings of individual words. Using phrases as features allows one to account for such phenomena. For example, a text may contain a word “Web” in one part of the document, and a word “search” in another, unrelated part of the document, however, this does not necessarily mean the document is about Web search. On the other hand, if these two words appear adjacently, and the phrase “Web search” is recognized, then the document most likely indeed.

Although a current embodiment processes only three features from the search results 106, it swill be appreciated that additional features may be constructed. The feature X processing 114 represents production of such additional features. As shown, feature X processing involves a feature X extraction process 114-1, a feature X selection process 114-2 and a query feature X process. For example, additional features that may be extracted include (1) creating features based on additional sources of knowledge, e.g., other taxonomies, for instance, domain specific ontologies or for (2) building features representing geographic entities recognized in the text.

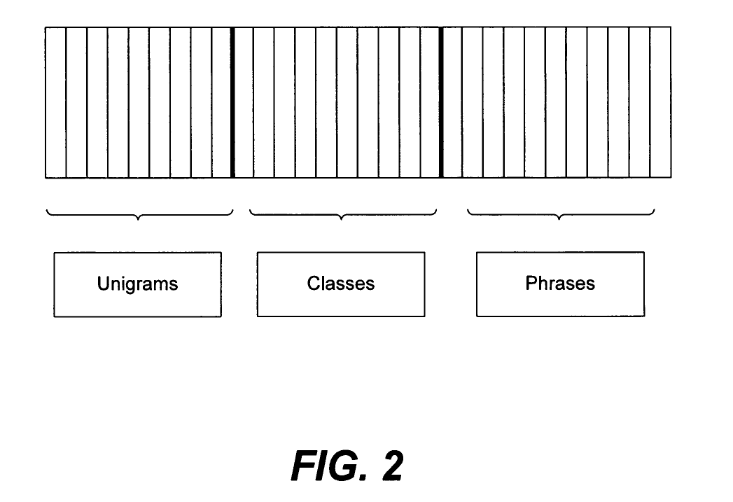

A query generation process 116 produces an ad query based upon the results of the unigram processing 108, classification processing 110 and phrase extraction processing 112 and other feature processing, e.g. feature X processing 114. The ad query generation process pools all the selected features together to create an ad query vector. FIG. 2 is an illustrative drawing of an ad query vector in accordance with some embodiments of the invention.

Advertisements are similarly processed to represent the ads in the same multiple distinct feature spaces in which the search results are represented. An ad database 118 includes a multiplicity of advertisements. A feature extraction process 120 processes substantially the entire body of information contained within individual ads (e.g. title, creative, bid phrases, URL) to produce individual representations of the ads in terms of the same features contained in the ad query. The feature extraction process is essentially the same as that described above and involves unigram processing, classification processing and phrase processing of individual ads. The illustrative drawing of FIG. 2 also represents the structure of the feature space produced by the feature extraction process 120. An ad index process 124 produces an index useful in matching ad features to ad query features.

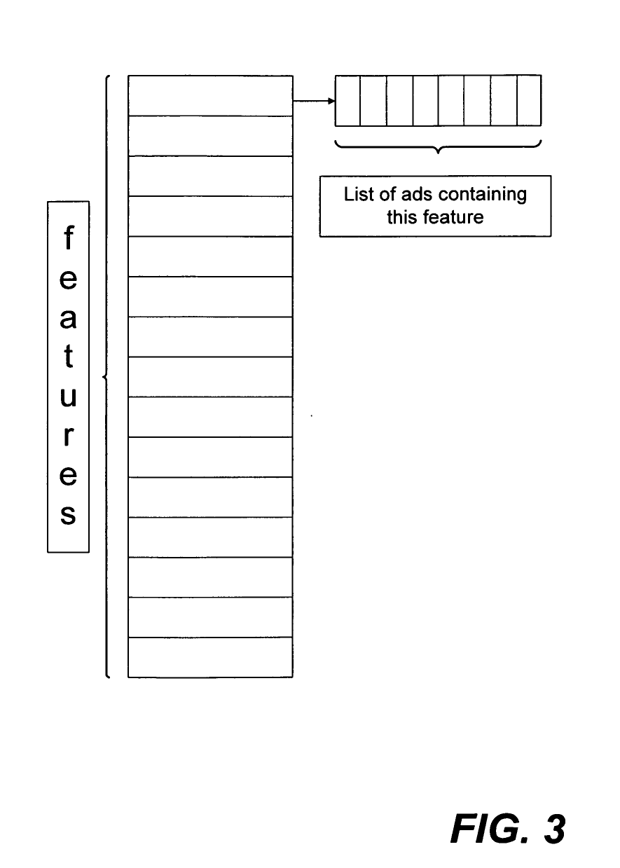

FIG. 3 is an illustrative drawing of an ad index structure in accordance with some embodiments of the invention. More particularly, the index comprises an inverted index of ads that for each feature provides a list of ads in which it appears. Given a query represented as a feature vector, such an index allows one to limit the search to only those ads that have some features in common with the query.

An ad search engine process 126 matches the ad query produced by the query generation process 116 against the ad index to identify ads having features that are similar to the features of the ad query. Ads represented as features with higher degrees of similarity to features of the ad query are likely to be more relevant to the user's original intent in forming the search query than are ads having lower levels of similarity. Accordingly, based upon measuring similarity between ad features and ad query features, the ad search engine process 126 identifies one or more ads 128 that are relevant to the user's original intent in formulating the Web search query.

More particularly, the search engine process 126 represents each object (e.g., ad query or ads) as a feature vector, which is composed of multiple sub-vectors, each of which is normalized and scored separately. Let q be an ad query, then its feature vector is defined as follows:

vq=<uq₁, . . . , uq_{|U|}, cq₁, . . . , cq_{|C|}, pq₁, . . . , pq_{|P|}>

here U, C and P are the sets of unigrams, classes and phrase features.

Given an ad a and its vector:

va=<ua₁, . . . , ua_{|U|}, ca₁, . . . , ca_{|C|}, pa₁, . . . , pa_{|P|}>

a similarity score for the ad and a query using cosine similarity metric:

$$score ( q , a ) = α {\sum }_{i = 1 … \vert U \vert} u {q}_{i} \cdot u {a}_{i} + β {\sum }_{j = 1 … \vert C \vert} c {q}_{j} \cdot c {a}_{j} + γ {\sum }_{k = 1 … \vert P \vert} p {q}_{k} \cdot p {a}_{k} , \qquad ( 1 )$$

where α, β and γ are the weights reflecting the importance of the different feature classes. Although currently three different kinds of features are used, the modular approach could easily incorporate additional feature types (e.g., feature x), which could be built using additional knowledge sources.

### Feature Construction

### Bag of Words

A ‘blind relevance’ feedback approach is adopted that assumes that the top scoring search results according to the Web search engine criteria are relevant to the original search query at least to some degree. A word-level unigram of features U is constructed by pooling together individual unigrams that occur in the selected search results pages. Taking all the unigrams that occur in any of the results pages would be quite noisy. Hence, it is advantageous to select unigrams that are truly characteristic of the search results. Consequently, a feature selection process is employed that seeks to retain only features that have true affinity with the query. In some embodiments, metrics based on document frequency and TFIDF are employed to select the most relevant unigrams to serve as features. Once a desired number of features (i.e., unigrams) has been selected, the features values are assigned using a TFIDF scheme that uses logarithmic term frequency and IDF computed over the ad corpus. See, for example, Gerard Salton and Chris Buckley. Term weighting approaches in automatic text retrieval, Information Processing and Management, 24(5):513{523, 1988. Precisely, feature weights are computed as,

uqᵢ=(1+log(tƒ))NA/NA(uqᵢ),

where tƒ is the number of occurrences of uqᵢ in the pooled search results ∪ᵢ, rᵢ, NA is the total number of ads, and NAᵤ is the number of ads whose text contains the word uqᵢ. Finally, unigram weights undergo L2-normalization:

$$u {q}_{i}^{′} = \frac{u {q}_{i}}{\sqrt{{\sum }_{i = 1 … \vert U \vert} u {q}_{i}^{2}}}$$

### Query Classification

If a search query and an ad are highly related but use different vocabulary, the bag of words matching may be insufficient to capture their relatedness. To overcome this shortcoming, a text classification with respect to an external taxonomy is used to identify commonalities between related but different vocabularies. The external taxonomy may comprise a tree structure that represents a hierarchy of concepts in human knowledge related to text.

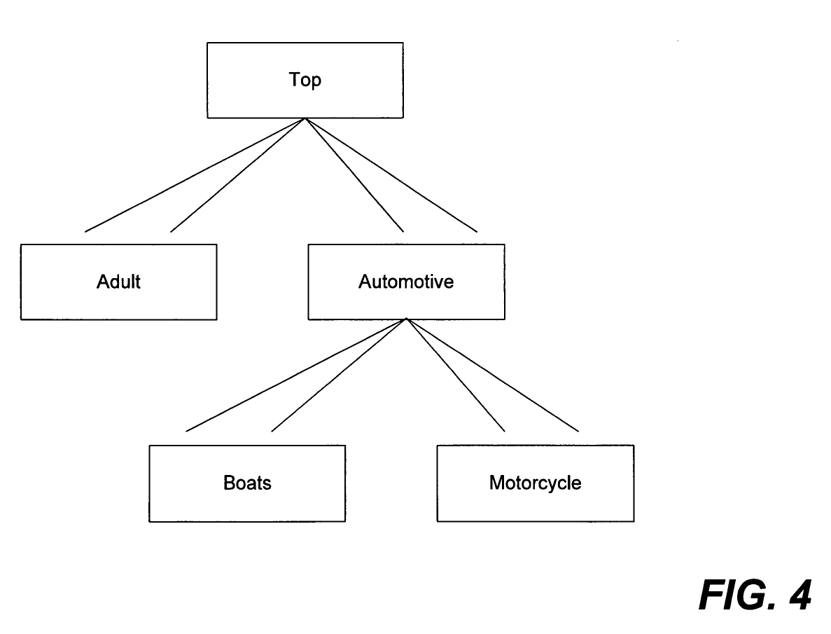

FIG. 4 is an illustrative drawing of a portion of an external taxonomy showing branching and a hierarchy of feature nodes in accordance with some embodiments of the invention. Nodes in the taxonomy correspond to concepts and to text indicative of such concepts. A concept may be represented at various levels of abstraction through nodes at different levels in the tree structure. Each level lower level can represent a further refinement of the concept or a more specific example of the concept.

To achieve this aim, a large taxonomy of commercial-intent topics is used. A document classifier is constructed that is capable of mapping an input fragment of text into a number of relevant classes. Doing so not only allows generalization from the level of individual words to higher-level abstractions, but also explicitly benefits from the external knowledge that was used to build this auxiliary classifier.

The choice of a classifier taxonomy is guided by a Web advertising application. Since one objective is to achieve the classes that are useful for matching ads, the taxonomy should be elaborate enough to facilitate ample classification specificity. For example, classifying all medical queries into one node will likely result in poor ad matching, as both “sore foot” and “flu” queries will end up in the same node. The ads appropriate for these two queries are, however, very different. To avoid such situations, a taxonomy is employed that provide sufficient discrimination between common commercial topics.

Therefore, a large taxonomy of approximately 6,000 nodes is employed. The nodes are arranged in a hierarchy with median depth 5 and maximum depth 9. Human editors populated the taxonomy with labeled bid phrases of actual ads (approximately 150 phrases per node), which were used as a training set. See, for example, Andrei Broder et al., “Robust classification of rare queries using web knowledge,” in Proceedings of the 30th ACM International Conference on Research and Development in Information Retrieval, 2007, which is expressly incorporated in its entirety herein by this reference.

Machine learning techniques perform classification. The classification challenge is especially difficult in view of the relatively large number of different classes and about an order of magnitude more of training examples. Some suitable candidates include the nearest neighbor and the Naive Bayes classifier, (see, for example, Richard Duda and Peter Hart, Pattern Classification and Scene Analysis, John Wiley and Sons, 1973), as well as prototype formation methods such as Rocchio (see, for example, Joseph John Rocchio, “Relevance feedback in information retrieval,” in The SMART RetrievalSystem: Experiments in Automatic Document Processing, pages 313-323, Prentice Hall, 1971) or centroid-based classifiers (Eui-Hong (Sam) Han and George Karypis, “Centroid-based document classification: Analysis and experimental results,” in Proceedings of the Fourth European Conference on Principles and Practice of Knowledge Discovery in Databases, September 2000).

A centroid method is used to implement a text classifier in accordance with some embodiments of the invention. In general, text classification involves assigning category labels to natural language documents. Categories come from a fixed set of labels (possibly organized in a hierarchy) and each document may be assigned one or more categories. Text categorization systems are useful in a wide variety of tasks, such as routing news and e-mail to appropriate corporate desks, identifying junk email, or correctly handling intelligence reports.

In accordance with a centroid method, for each taxonomy node, all the phrases associated with this node were concatenated into a single meta-document. A centroid was computed for each node by summing up the TFIDF values of individual terms, and normalizing by the number of phrases in the class,

$${{c}^{->}}_{j} = \frac{1}{\vert {C}_{j} \vert} {\sum }_{{p}^{->} ∈ {C}_{j}} \frac{{p}^{->}}{‖ {p}^{->} ‖}$$

where \vec{c}ⱼ is the centroid for class Cⱼ and p iterates over the phrases in a particular class.

The classification is based on the cosine of the angle between the input document and the centroid meta-documents:

$${C}_{max} = ar {g max}_{{C}_{j} ∈ C} \frac{{{c}^{->}}_{j}}{‖ {{c}^{->}}_{j} ‖} \cdot \frac{{{d}^{->}}_{j}}{‖ {{d}^{->}}_{j} ‖}$$

$${C}_{max} = arg {max}_{{C}_{j} ∈ C} \frac{{\sum }_{i ∈ \vert F \vert} {c}^{i} \cdot {d}^{i}}{\sqrt{{\sum }_{i ∈ \vert F \vert} {( {c}^{i} )}^{2}} \sqrt{{\sum }_{i ∈ \vert F \vert} {( {d}^{i} )}^{2}}}$$

where F is the bag of words, and cⁱ and dⁱ represent the weight of the ith feature in the class centroid and the document, respectively. The scores are normalized by the document and centroid lengths to make the scores of different documents comparable. Given the search results produced for the Web search query each result page is classified, and then a voting process is performed voting among them to select several classifications that best characterize the query.

Following the approach proposed by Evgeniy Gabrilovich and Shaul Markovitch, Feature generation for text categorization using world knowledge. In Proceedings of the 19th International Joint Conference on Artificial Intelligence, pages 1048-1053, Edinburgh, Scotland, August 2005, which is expressly incorporated herein by this reference, features are constructed based on these immediate classifications as well as their ancestors in the taxonomy (the weight of each ancestor feature was decreased with a damping factor of 0.5). The weights of classification features are essentially defined by the confidence scores assigned by the document classifier. In some embodiments, the only transformation applied to these scores is cosine normalization.

### Phrase Extraction

The phrase extraction process tool involves two components, an online and an offline one. Given a fragment of text, the online component analyzes the given text to identify named entities and other stable phrases. In some embodiments, this component has been integrated into the crawling and indexing pipeline of the Web search engine process 104, and is routinely invoked on all the pages included in the Web search engine index. The offline component collectively analyzes the phrases found in all the crawled pages, and retains the most significant ones based on their statistical properties. These phrases can then be used as a restricted lexicon for indexing any piece of text in which they occur. These online and offline components are described in, Peter Anick, “Using terminological feedback for web search refinement: a log-based study” in SIGIR'03, pages 88-95, 2003, which is expressly incorporated herein by this reference. In some embodiments, approximately 10 million phrases (referred to herein as ‘Prisma’ terms) are selected for the English language.

Prisma terms (i.e. phrases) are identified that appear in the search results (e.g. Web pages). Feature selection is performed to retain the most characteristic phrases. Both feature selection and TFIDF-based feature weighting are performed similarly to the processing of unigrams explained above.

The above three-stage feature construction process results in a set of augmented queries, which are represented using three kinds of features: unigrams, classes, and phrases. In contrast to a few words that comprised the original Web search query, these additional features have been constructed by collectively analyzing the set of search results produced for the original Web search query. The augmented query actually becomes the above-described ad query, that is evaluated against an index of ads to retrieve relevant ads.

### Ad Indexing and Retrieval

The ads, which are stored in an ad database, are available ahead of time. In some embodiments, processing of ads is performed offline. In some embodiments, ‘Hadoop’ grid-computing infrastructure (lucene.apache.org/hadoop/) is used. Hadoop is a framework for parallelizing computations over a large set of networked computers. The same task can be achieved on a single computer with ample memory and disk storage, but it would take much more time. The ad text is evaluated, and the same three types of features are constructed for the ads, namely, unigrams, classes, and phrases. In an online advertising system, the number of ads can easily reach tens and even hundreds of millions. Therefore, to facilitate fast ad search and retrieval an inverted index of ads has been constructed, as illustrated in FIG. 3. Finding relevant ads for the query amounts to efficiently evaluating the scores of candidate ads as defined by equation (1) above, and then retrieving the desired number of highest-scoring ads.

As opposed to traditional search engines where the queries are short and documents are long, in the case of embodiments of the present invention, ad queries are composed of Web-based features (as explained in the preceding section), and are fairly long. For example, as illustrated in FIG. 2, an ad query may have on average 100-200 features, more than the number of features constructed for some ads. Therefore, we are not looking for a subsumption of the query vector by the ad vector; instead, we search for ads that are most similar to the query. To efficiently perform the similarity search over the ad space, we have adapted the WAND (weighted AND) algorithm, described in, Andrei Z. Broder et al., “Efficient query evaluation using a two-level retrieval process,” in Proceedings of the 12th ACM International Conference on Information and Knowledge Management, pages 426-434, 2003, which is expressly incorporated herein by this reference, to work with longer queries. WAND uses a branch-and-bound approach to reduce the number of ads considered. For each query feature, one cursor is opened to traverse the posting lists. The cursors are moved based on the upper bound of the score of the document that the cursor currently points at. Only documents with upper bounds higher than the minimal score in the current candidate set are considered.

### Details of Classification Procedures

The following discussion is taken in part from Andrei Broder et al., “Robust classification of rare queries using web knowledge,” in Proceedings of the 30th ACM International Conference on Research and Development in Information Retrieval, 2007, which has been expressly incorporated herein by this reference.

### Taxonomy

The choice of classification taxonomy was guided by a Web advertising application. Since the classes are to be useful for matching ads to queries, the taxonomy should elaborate enough to facilitate ample classification specificity. Therefore, an elaborate taxonomy of approximately 6000 nodes, arranged in a hierarchy with median depth 5 and maximum depth 9 is employed. Human editors populate the taxonomy with labeled queries (approximately 150 queries per node), which were used as a training set; a small fraction of queries have been assigned to more than one category.

### Building the Document Classifier

In this work we used a commercial classification taxonomy of approximately 6000 nodes used in a major U.S. search engine. Human editors populated the taxonomy nodes with labeled examples that we used as training instances to learn a document classifier. Given a taxonomy of this size, the computational efficiency of classification is a major issue. Few machine learning algorithms can efficiently handle so many different classes, each having hundreds of training examples. As explained above, a centroid classfier was selected.

### Query Classification by Search

Having developed a document classifier for the query taxonomy, we now turn to the problem of obtaining a classification for a given query based on the initial search results it yields. Let's assume that there is a set of documents D=d₁ . . . dₘ indexed by a search engine. The search engine can then be represented by a function \vec{ƒ}=similarity(q,d) that quantifies the affinity between a query q and a document d. Examples of such affinity scores used in this disclosure are rank—the rank of the document in the ordered list of search results; static score—the score of the goodness of the page regardless of the query (e.g., PageRank); and dynamic score—the closeness of the query and the document.

Query classification is determined by first evaluating conditional probabilities of all possible classes P(Cj|q), and then selecting the alternative with the highest probability Cₘₐₓ=arg max cⱼ ∈cP(cⱼ|q). The goal is to estimate the conditional probability of each possible class using the search results initially returned by the query.

We use the following formula that incorporates classifications of individual search results:

$${\sum }_{d ∈ D} P ( {C}_{j} \vert q , d ) \cdot P ( d \vert q ) = {\sum }_{d ∈ D} \frac{P ( q \vert {C}_{j} , d )}{P ( q \vert d )} \cdot P ( {C}_{j} \vert q , d ) \cdot P ( d \vert q )$$

We assume that P(q|Cⱼ,d)≈P(q|d), that is, a probability of a query given a document can be determined without knowing the class of the query. This is the case for the majority of queries that are unambiguous. Counter examples are queries like ‘jaguar’ (animal and car brand) or ‘apple’ (fruit and computer manufacturer), but such ambiguous queries can not be classified by definition, and usually consist of common words. In this work the primary focus is on rare queries, that tend to contain rare words, be longer, and match fewer documents; consequently in our setting this assumption mostly holds. Using this assumption, we can write

$$P ( {C}_{j} \vert q ) = {\sum }_{d ∈ D} P ( {C}_{j} \vert d ) \cdot P ( d \vert q ) .$$

The conditional probability of a classification for a given document P(Cj|d) is estimated using the output of the document classifier (section 2.1). While P(d|q) is harder to compute, we consider the underlying relevance model for ranking documents given a query.

### Classification Based Relevance Model

In order to describe a formal relationship of classification and ad placement (or search), we consider a model for using classification to determine ads (or search) relevance. Let a be an ad and q be a query, we denote by R(a,q) the relevance of a to q. This number indicates how relevant the ad a is to query q, and can be used to rank ads a for a given query q. We consider the following approximation of relevance function:

$$R ( a , q ) \approx {R}_{C} ( a , q ) = {\sum }_{{C}_{j} ∈ C} w ( {C}_{j} ) s ( {C}_{j} , a ) s ( {C}_{j} , q )$$

The right hand side expresses how we use the classification scheme C to rank ads, where s(c,a) is a scoring function that specifies how likely a is in class c, and s(c,q) is a scoring function that specifies how likely q is in class c. The value w(c) is a weighting term for category c, indicating the importance of category c in the relevance formula.

This relevance function is an adaptation of the traditional word-based retrieval rules. For example, we may let categories be the words in the vocabulary. We take s(Cⱼ,a) as the word counts of Cⱼ in a, s(Cⱼ,q) as the word counts of Cⱼ in q, and w(Cⱼ) as the IDF term weighting for word Cⱼ. With such choices, the method given by (1) becomes the standard TFIDF retrieval rule.

If we take s(Cⱼ,a)=P(Cj|a), s(Cⱼ,q)=P(Cj|q), and w(Cⱼ)=1/P(Cj), and assume that q and a are independently generated given a hidden concept C, then we have

$${R}_{C} ( a , q ) = {\sum }_{{C}_{j} ∈ C} P ( {C}_{j} \vert a ) P ( {C}_{j} \vert q ) / P ( {C}_{j} ) {\sum }_{{C}_{j} ∈ C} P ( {C}_{j} \vert a ) P ( q \vert {C}_{j} ) / P ( q ) = p ( q \vert a ) / P ( q )$$

That is, the ads are ranked according to P(q|a). This relevance model has been employed in various statistical language modeling techniques for information retrieval. The intuition can be described as follows. We assume that a person searches an ad a by constructing a query q: the person first picks a concept Cⱼ according to the weights P(Cⱼ|a), and then constructs a query q with probability P(q|Cⱼ) based on the concept Cⱼ. For this query generation process, the ads can be ranked based on how likely the observed query is generated from each ad.

It should be mentioned that in our case, each query and ad can have multiple categories. For simplicity, we denote by Cⱼ a random variable indicating whether q belongs to category Cⱼ. We use P(Cⱼ|q) to denote the probability of q belonging to category Cⱼ. Here the sum Σ_{C}_{ⱼ}_{∈C} P(Cⱼ|q) may not be equal to one. We then consider the following ranking formula:

$${R}_{C} ( a , q ) = {\sum }_{{C}_{j} ∈ C} P ( {C}_{j} \vert a ) P ( {C}_{j} \vert q ) . \qquad ( 2 )$$

We assume the estimation of P(Cⱼ|a) is based on an existing text-categorization system (which is known). Thus, we only need to obtain estimates of P(Cⱼ|q) for each query q. Equation (2) is the ad relevance model that we consider with unknown parameters P(Cⱼ|q) for each query q. In order to obtain their estimates, we use search results from major U.S. search engines, where we assume that the ranking formula in (2) gives good ranking for search. That is, top results ranked by search engines should also be ranked high by this formula. Therefore given a query q, and top K result pages d₁(q), . . . ,d_{K}(q) from a major search engine, we fit parameters P(Cⱼ|q) so that R_{C}(dᵢ(q),q) have high scores for i=1, . . . ,K. Using this method computes relative strength of P(Cⱼ|q) but not the scale, because scale does not affect ranking. Moreover, it is possible that the parameters estimated maybe of the form g(P(Cⱼ|q)) for some monotone function g(·) of the actually conditional probability g(P(Cⱼ|q)). Although this may change the meaning of the unknown parameters that we estimate, it does not affect the quality of using the formula to rank ads. Nor does it affect query classification with appropriately chosen thresholds. In what follows, we consider two methods to compute the classification information P(Cⱼ|q).

### The Voting Method

We would like to compute P(Cⱼ|q) so that R_{C}(dᵢ(q),q) are high for i=1, . . . ,K and R_{C}(d,q) are low for a random document d. Assume that the vector [P(Cⱼ|d)]cⱼ∈c is random for an average document, then the condition that Σ_{C}_{ⱼ}_{∈C}P(Cⱼ|q)² is small implies that R_{C}(d,q) is also small averaged over d. Thus, a natural method is to maximize

$${\sum }_{i = 1}^{K} {w}_{i} {R}_{C} ( {d}_{i} ( q ) , q )$$

subject to Σ_{C}_{ⱼ}_{∈C}P(Cⱼ|q)² being small, where wᵢ are weights associated with each rank i:

$${max}_{[ P ( \cdot \vert q ) ]} [ \frac{1}{K} {\sum }_{i = 1}^{K} {w}_{i} {\sum }_{{C}_{j} ∈ C} P ( {C}_{j} \vert {d}_{i} ( q ) ) P ( {C}_{j} \vert q ) - λ {\sum }_{{C}_{j} ∈ C} {P ( {C}_{j} \vert q )}^{2} ] ,$$

where we assume

$${\sum }_{i = 1}^{K} {w}_{i} = 1 , and γ > 0$$

is a tuning regularization parameter. The optimal solution is

$$P ( {C}_{j} \vert q ) = \frac{1}{2 λ} {\sum }_{i = 1}^{K} P ( {C}_{j} \vert {d}_{i} ( q ) ) .$$

Since both P(Cⱼ|_{di}(q)) and P(Cⱼ|q) belong to [0, 1], we may just take λ=0.5 to align the scale. In the experiment, we will simply take uniform weights wᵢ. A more complex strategy is to let w depend on d as well:

$$P ( {C}_{j} \vert q ) = {\sum }_{d} w ( d , q ) g ( P ( {C}_{j} \vert d ) )$$

where g(x) is a certain transformation of x. In this general formulation, w(d, q) may depend on factors other than the rank of d in the search engine results for q. For example, it may be a function of r(d, q) where r(d, q) is the relevance score returned by the underlying search engine. Moreover, if we are given a set of hand-labeled training category/query pairs (C, q), then both the weights w(d, q) and the transformation g(·) can be learned using standard classification techniques.
Discriminative classification

We can treat the problem of estimating P(Cⱼ|q) as a classification problem, where for each q, we label dᵢ(q) for i=1, . . . ,K as positive data, and the remaining documents as negative data. That is, we assign label yᵢ(q)=1 for dᵢ(q) when i≦K, and label yᵢ(q)=−1 for dᵢ(q) when i>K.

In this setting, the classification scoring rule for a document dᵢ(q) is linear. Let xᵢ(q)=[P(Cⱼ|dᵢ(q))], and w=[P(Cⱼ|q)], then Σ_{C}_{ⱼ}_{∈C}P(Cⱼ|q)P(Cⱼ|dᵢ(q))=w·xᵢ(q). The values P(Cⱼ|d) are the features for the linear classifier, and P(Cⱼ|d) is the weight vector, which can be computed using any linear classification method. We consider estimating w using logistic regression [17] as follows: P(·|q)=arg min_{w} Σ₁ ln(1+e^{-w·x}^{₁}^{(q)y}^{ᵢ}^{(q)}).

A query classification system in accordance with some embodiments of the invention is further described in co-pending commonly owned U.S. patent application Ser. No. ______, filed Feb. 20, 2007, entitled, Query Classification and Selection of Associated Advertising Information, invented by A. Z. Broder, V. Josifovski and M. Fontoura, which is expressly incorporated herein by theis reference.

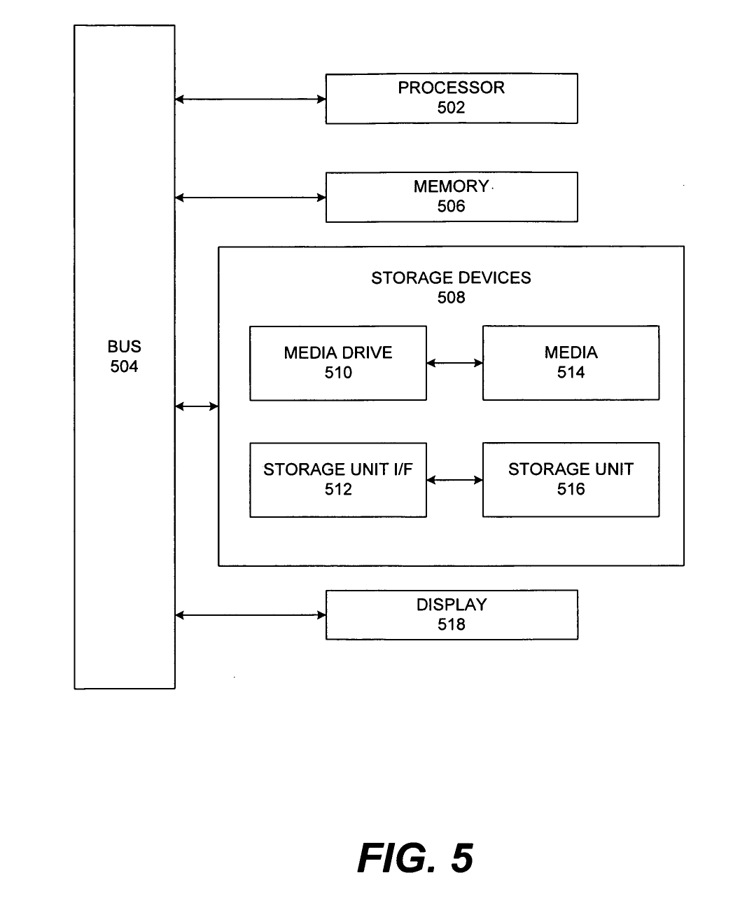

FIG. 5 is an illustrative block level diagram of a computer system 500 that can be programmed to implement processes involved with extracting feature information from Web search results and with classification of text from Web search results according to an external classification taxonomy in accordance with embodiments of the invention. Computer system 500 can include one or more processors, such as a processor 502. Processor 502 can be implemented using a general or special purpose processing engine such as, for example, a microprocessor, controller or other control logic. In the example illustrated in FIG. 5, processor 502 is connected to a bus 504 or other communication medium.

Computing system 500 also can include a main memory 506, preferably random access memory (RAM) or other dynamic memory, for storing information and instructions to be executed by processor system 502. Main memory 506 also may be used for storing temporary variables or other intermediate information during execution of instructions to be executed by processor 502. Computer system 500 can likewise include a read only memory (“ROM”) or other static storage device coupled to bus 504 for storing static information and instructions for processor system 502. The main memory 506 and the storage devices 508 may store data such as an test pattern database or design database or a computer program such as an integrated circuit design simulation process, for example. The main memory 506 and the storage devices 508 may store instructions such as instructions to retain the most important unigrams and to phrases from among Web pages included in Web search results and to classify text from the Web pages in accordance with an external classification system. The main memory 506 and the storage devices 508 also may store instructions to determine similarity between an ad query vectors and respective ad feature vectors based upon cosine, for example.

The computer system 500 can also includes information storage mechanism 508, which can include, for example, a media drive 510 and a removable storage interface 512. The media drive 510 can include a drive or other mechanism to support fixed or removable storage media 514. For example, a hard disk drive, a floppy disk drive, a magnetic tape drive, an optical disk drive, a CD or DVD drive (R or RW), or other removable or fixed media drive. Storage media 514, can include, for example, a hard disk, a floppy disk, magnetic tape, optical disk, a CD or DVD, or other fixed or removable medium that is read by and written to by media drive 510. Information storage mechanism 1408 also may include a removable storage unit 516 in communication with interface 512. Examples of such removable storage unit 516 can include a program cartridge and cartridge interface, a removable memory (for example, a flash memory or other removable memory module). As these examples illustrate, the storage media 514 can include a computer useable storage medium having stored therein particular computer software or data. An ad query vector and ad feature vectors may be stored using the information storage mechanism, for example.

The computer system 500 also includes a display unit 518 that can be used to display information such as search query, search results or ads. Moreover, the display unit can be used to display toggle information associated with one or more proposed test patterns.

In this document, the terms “computer program medium” and “computer useable medium” are used to generally refer to media such as, for example, memory 506, storage device 508, a hard disk installed in hard disk drive 510. These and other various forms of computer useable media may be involved in carrying one or more sequences of one or more instructions to processor 502 for execution. Such instructions, generally referred to as “computer program code” (which may be grouped in the form of computer programs or other groupings), when executed, enable the computing system 500 to perform features or functions of the present invention as discussed herein.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

1. A method to augment a Web search query comprising:
receiving Web search engine search results responsive to the search query;
extracting features from the search results that are characteristic of the search results;
mapping text of the search results to classification features indicative of concepts associated with the text; and
saving an ad query vector that includes the extracted features and the mapped features.

2. The method of claim 1 further including:
selecting top ranked Web search engine results according to search engine criteria used by the search engine.

3. The method of claim 1,
wherein receiving Web search engine results includes receiving Web pages responsive to the search query.

4. The method of claim 1,
wherein extracting features includes selecting unigram features from the search results that are characteristic of the search results.

5. The method of claim 1,
wherein extracting features includes selecting phrase features from the search results that are characteristic of the search results.

6. The method of claim 1,
wherein mapping text of the search results to classification features includes mapping text from the search results to classification feature nodes of an external classification system.

7. A method to augment a Web search query comprising:
receiving Web search engine search results responsive to the search query;
selecting unigram features from the search results that are characteristic of the search results;
mapping text from the search results to classification feature nodes of an external classification system that associates text with classification features;
selecting phrase features from the search results that are characteristic of the search results; and
saving an ad query vector that includes the selected unigram features, the mapped to classification features and the selected phrase features.

8. The method of claim 7,
wherein selecting unigram features includes selecting respective unigrams based upon frequency of occurrence of such unigrams in the search results.

9. The method of claim 7,
wherein mapping of mapping text from the search results to classification feature nodes includes mapping to an external classification taxonomy that associates text with a hierarchy of classification features that correspond to concepts at different levels of abstraction.

10. The method of claim 7,
wherein selecting phrase features includes selecting respective phrases based upon frequency of occurrence of such phrases in the search results.

11. A method to match an advertisement to a search query comprising:
receiving Web search engine search results responsive to the search query;
extracting features from the search results that are characteristic of the search results;
mapping text of the search results to classification features indicative of concepts associated with the text;
saving an ad query vector that includes the extracted features and the mapped features;
obtaining respective ad feature vectors that represent respective ads in terms of the same kinds of features included in the ad query vector; and
selecting one or more respective ads based upon a measure of similarity of the ad query vector to respective ad feature vectors.

12. The method of claim 11,
wherein obtaining respective ad feature vectors includes:
extracting features from respective advertisements that are characteristic of such respective advertisements; and
mapping text of the respective advertisements to classification features indicative of concepts associated with the text.

13. The method of claim 12,
wherein obtaining further includes retrieving ads from an ad database.

14. The method of claim 12,
wherein extracting features from respective advertisements includes extracting from an ad title.

15. The method of claim 12,
wherein extracting features from respective advertisements includes extracting from an ad creative.

16. The method of claim 12,
wherein extracting features from respective advertisements includes extracting from ad bid phrases.

17. The method of claim 12,
wherein extracting features from respective advertisements includes extracting from an ad URL.

18. The method of claim 12,
wherein extracting features from respective advertisements includes extracting from at least two of the following: ad title, ad creative, ad bid phrase and ad URL.

19. The method of claim 12,
wherein obtaining includes retrieving from an advertisement database.

20. The method of claim 12 further including:
building an inverted ad index; and
using the inverted ad index to compare respective ad feature vectors to the ad query vector.

21. An apparatus for use with a Web search engine comprising:
a processor system;
memory storage; and
a bus to communicate information between the processor and memory storage;
wherein the memory is encoded with computer readable instructions to cause the processor system to perform steps of:
receiving Web search engine search results responsive to the search query;
extracting features from the search results that are characteristic of the search results;
mapping text of the search results to classification features indicative of concepts associated with the text; and
saving an ad query vector that includes the extracted features and the mapped features.

22. An apparatus for use with a Web search engine comprising:
a processor system;
memory storage; and
a bus to communicate information between the processor and memory storage;
wherein the memory is encoded with computer readable instructions to cause the processor system to perform a process comprising:
receiving Web search engine search results responsive to the search query;
extracting features from the search results that are characteristic of the search results;
mapping text of the search results to classification features indicative of concepts associated with the text; and
saving an ad query vector that includes the extracted features and the mapped features;
obtaining respective ad feature vectors that represent respective ads in terms of the same kinds of features included in the ad query vector; and
selecting one or more respective ads based upon a measure of similarity of the ad query vector to respective ad feature vectors.

23. The apparatus of claim 22,
wherein obtaining respective ad feature vectors includes:
extracting features from respective advertisements that are characteristic of such respective advertisements;
mapping text of the respective advertisements to classification features indicative of concepts associated with the text;
saving respective ad feature vectors that include the extracted features and the mapped features for respective ads.

24. The apparatus of claim 22,
wherein obtaining further includes retrieving ads from an ad database.

25. The apparatus of claim 22,
wherein the process further includes:
building an inverted ad index; and
using the inverted ad index to compare respective ad feature vectors to the ad query vector.

26. An article of manufacture including computer readable medium encoded with instructions to cause a processing system to perform a process that includes:
receiving Web search engine search results responsive to the search query;
extracting features from the search results that are characteristic of the search results;
mapping text of the search results to classification features indicative of concepts associated with the text; and
saving an ad query vector that includes the extracted features and the mapped features.

27. An article of manufacture including computer readable medium encoded with instructions to cause a processing system to perform a process that includes:
receiving Web search engine search results responsive to the search query;
extracting features from the search results that are characteristic of the search results;
mapping text of the search results to classification features indicative of concepts associated with the text;
saving an ad query vector that includes the extracted features and the mapped features;
obtaining respective ad feature vectors that represent respective ads in terms of the same kinds of features included in the ad query vector; and
selecting one or more respective ads based upon a measure of similarity of the ad query vector to respective ad feature vectors.
